(19) United States
(12) Patent Application Publication
(10) Pub. No.: US 2018/0352135 A1
(43) Pub. Date: Dec. 6, 2018

(54) Beacon based system to automatically activate a remote camera based on the proximity of a smartphone

(71) Applicant: Jacob Mark Fields, San Diego, CA (US)

(72) Inventor: Jacob Mark Fields, San Diego, CA (US)

(21) Appl. No.: 15/615,755

(22) Filed: Jun. 6, 2017

(51) Int. Cl. H04N 5/232; H04W 4/02

(52) U.S. Cl. CPC H04N 5/23206; H04L 67/12; H04W 4/023

(57) ABSTRACT

Beacon based systems to automatically activate a remote camera based on the proximity of a smartphone. Elements include a smartphone specialized software, a beacon and specialized software on a microcomputer which can seamlessly provide location based activation of a camera and transmission of the resultant photo back to the smartphone. One aspect includes a system of using a beacon with a beacon, a sensor, a computer enabled device for communicating with the beacon over a wireless network, and a remote storage device. The computer enabled device can communicate with the beacon over a wireless network and the computer enabled device detects the beacon when the beacon is within a predetermined range of the computer enabled device. Once the beacon is detected, the computer enabled device triggers the sensor and the sensor actuates, outputs a digital file, and transmits the file to a remote storage device.

### CROSS-REFERENCES TO RELATED PATENT APPLICATIONS

The subject matter described in the present application is related to that described in the U.S. patent application Ser. No. 62/345,941 to Jacob Mark Fields filed Jun. 6, 2016, now pending, which is incorporated by reference herein in its entirety.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX

Not Applicable.

### BACKGROUND

With the advent of personal digital cameras, interest in picture taking and sharing has radically increased. There are places where cameras and other types of sensors could be ideally placed but are either difficult or unsafe to reach. The prior art has not used the unique combinations of the present embodiments, for example the presence of a target user and smartphone relative to the location of a beacon.

### SUMMARY

Embodiments of the claimed subject matter relate to sensing devices such as digital cameras and more particularly to apparatuses, methods and systems for taking pictures with smartphones and sharing pictures. Other embodiments relate to systems and methods for using other sensing devices that are remotely triggered with the output sent to one or more users and/or one or more storage devices.

One aspect includes a system of using a beacon with a beacon, a sensor, a computer enabled device for communicating with the beacon over a wireless network, and a remote storage device. The computer enabled device can communicate with the beacon over a wireless network and the computer enabled device detects the beacon when the beacon is within a predetermined range of the computer enabled device. Once the beacon is detected, the computer enabled device triggers the sensor and the sensor actuates, outputs a digital file, and transmits the file to a remote storage device.

Another system includes the use of more than one sensor. Other systems include the use of a camera as the sensor. Other systems include the use of more than one beacon and/or more than one remote storage devices. In many of the embodiments, the one or more beacons used in the systems are powered by a battery. In other embodiments, the wireless network is wired network. In some embodiments, the wireless network is connected to the internet.

Other embodiments include a computer enabled device that can communicate with the beacon over a wired network. Some of the embodiments have a computer enabled device that is at least one smartphone each with one or more cameras for recording and outputting images.

In other embodiments, the computer enabled device is at least one smartphone each with one or more audio recording devices for recording and outputting sounds. In other embodiments, the computer enabled device is includes one or more scales for recording and outputting a user's weight.

In some embodiments, the system includes, instead of a single beacon, three are more beacons that are additionally used to triangulate the location of a user and output the location data to said remote storage device. In some of these embodiments, the image is output along with the location data to the remote storage device. In other embodiments, the image is multiple images taken from multiple camera sources. In some of these embodiments, the multiple images are used to create a 3D print file such as a STL format file which can then be used to 3D print articles based on the 3D print file.

In other embodiments, the system has a computer enabled device wireless which transmits a set of alphanumeric codes to said beacon when said beacon is within a predetermined range of the computer enabled device. The alphanumeric codes can be associated with the output of the system and other logging data.

### DETAILED DESCRIPTION OF THE DRAWINGS

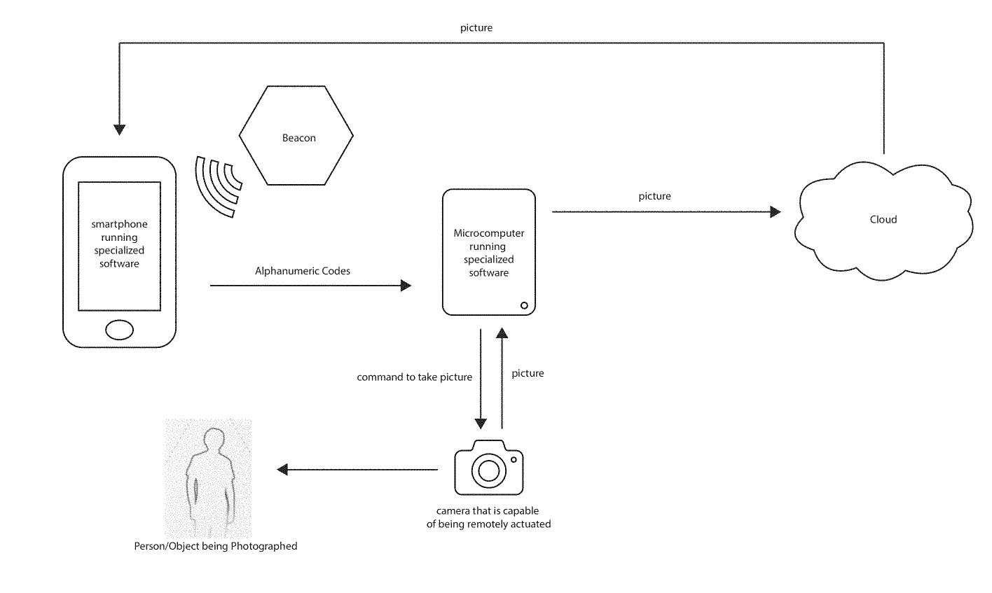

FIG. 1 is a chart showing the components of several embodiments of the claimed subject matter.

### DETAILED DESCRIPTION OF THE EMBODIMENTS

According to embodiments of the claimed subject matter, various systems of remotely triggering sensing devices such as cameras are provided. The computer implemented systems of remotely triggering sensors and storing the output of the claimed subject matter may be generally described with reference to FIG. 1, showing, but not limited to, certain exemplary embodiments of the inventive subject matter.

Several embodiments of the present inventive subject matter combine a smartphone specialized software, a beacon and specialized software on a microcomputer to seamlessly provide location based activation of a camera and transmission of the resultant photo back to the smartphone and/or a cloud based server.

As stated above, with the advent of personal digital cameras, interest in picture taking and sharing has radically increased. There are places where a camera could be ideally placed but are either difficult or unsafe to reach. The described embodiments of the inventive subject matter solve this problem.

This invention uses the precise location of the smartphone relative to the beacon. Previously, if a venue such as a ski resort, casino, or the like wanted to locate a camera in normally inaccessible places for guests to use, the guest user would have to manually activate the camera. The present embodiments allow the camera to be remotely activated based on the location of the user.

In these embodiments, by enabling beacon detection in specialized smartphone software and specialized software in a microcomputer that controls the camera, the location of a person at the photo location can be precisely determined and the camera activated to take a picture and transmitted back to the smartphone. In this way, the combination of smartphone specialized software, a beacon and specialized software on a microcomputer to seamlessly provide location based activation of a camera and transmission of the resultant photo back to the smartphone. The smartphone user can use the end product, a digital image produced by the embodiment.

Several of the embodiments herein include a microcomputer that is running an operating system that can access Wi-Fi networks and a radio that can communicate with a beacon; specialized software, on the microcomputer, that controls the Wi-Fi and beacon radio; a battery powered beacon that uses a radio; a camera that can be controlled by the microcomputer using a wired, Wi-Fi or other radio connection known to those skilled in the art; specialized software on the smartphone that can sense the beacon, communicate with the microcomputer and that can communicate with the internet. a smartphone that can run the specialized smartphone software, and an internet cloud containing specialized software that can communicate with the smartphone and the microcomputer.

In these embodiments, the smartphone (6) runs specialized smartphone software (5) and can detect or “see” the beacon (3) when in range. The microcomputer (1) runs the specialized microcomputer software (2) and communicates with the cloud (7), the smartphone software (5) and the camera (4).

In use in several embodiments, a smartphone (6) running the specialized software (5) detects a beacon within a pre-specified range. This causes the smartphone (6) to communicate with the microcomputer (1) using a radio and sending a set of alphanumeric codes. The microcomputer (1) then communicates with the camera (4) using any one of multiple methods. The camera (4) is instructed to take a picture and transfer the picture to the microcomputer (1). The microcomputer (1) transfers the picture to the cloud over the Internet (7). Whenever the smartphone (6) has access to the Internet, the specialized smartphone software (5) may get the picture from the cloud (7).

In these embodiments, the smartphone (6) must be within range of the beacon (3) which runs logic in specialized software (5). The microcomputer runs logic in specialized software (2) when activated by the smartphone.

In many of the described embodiment, multiple hardware components are used, for example, one or more cameras, audio recorders, weight recorders and other types of sensors.

The uniqueness of the embodiments includes various software components that can be run on a variety of different hardware components.

In Operation:

When in use, the user of these embodiments is not made aware of most of the underlying process as the user would only see the camera (4) and their smartphone (6). The remaining components would not be in view and the user would not be generally aware of the underlying functionally. In several embodiments, the user would undertake a one-time step to install the specialized software (5) on the smartphone (6).

In some embodiments, when the user approached a beacon, the beacon communicates with the camera to take a picture. The resulting output image from the camera is stored on a networked server as a digital photograph image. In other embodiments, when the beacon is approached, it communicates with a computer enabled device that communicates with the camera to take a picture.

In other embodiments, different devices can be used as one or more beacons. These beacons are used to verify a tight geo proximity, usually to a single user at a single point in time. In some embodiments, a BLE beacon is used but the one or more beacons could also be based on RFID or NFC technology, or on any beacon technology known to those skilled in the art. In other embodiments, a QR code or even a unique face could be used as a beacon. Other embodiments could include an audio cue as a beacon.

In other embodiments, the computer enabled device could be a headless linux device such as a mobile router in a vehicle instead of a smartphone. Beacons can also be remotely configured or reconfigured so they can be activated or deactivated manually or automatically, such as based on a timer.

In yet other embodiments, a linux computing device or a smartphone can be used to act as a beacon. This would allow more control of the functionality of the beacon device.

In other embodiments, multiple beacons and sensors such as cameras can exist in close proximity. For example, the embodiments can be configured to use one beacon with many cameras or many beacons to one camera. In several embodiments, a beacon or more than one beacon can locate a user and multiple cameras can be used to output a 3D print file based on the compilation of the images, for example an STL file. The STL file could then be used to print a miniature figurine of the target captured in the multiple images.

Several embodiments utilize smartphones but other embodiments may utilize other sensors such as weight sensors with the output the data read from the sensor. The output can be communicated to the user via his or her smartphone or it could be stored on a server connected to the internet. In this embodiment, a beacon would detect the presence of the user and smartphone on a scale, record the user's weight, and send the output to a server for storage and later retrieval.

Other embodiments could trigger any type of input device known to those skilled in the art. In one embodiment, video is captures and sent to a remote storage device. In other embodiments, IR/UV cameras and microphones can also be used in place of or in addition to traditional cameras such as smartphone cameras. The data sent in various forms can be stored on the remote storage server and then be retransmitted to projectors, lights, speakers, and the like.

Other embodiments can use the same or similar components to aid in inventory control and employee supervision. For example, a beacon could detect the presence of a vehicle at a location such as truck backing into a docking area. Once detected, the camera is triggered and an image of the truck is taken showing various stages of the truck being accessed. The images of the truck being unloaded could be used with additional artificial intelligent agents to aid in inventory and employee tracking. The stores images can be made available to automated algorithms as well as managers and employees.

Other embodiments can use the same or similar components to take one or more images of ski resort guests going up chairlift getting their photo taken at one or multiple lift towers or images of guests traversing down one or more specifically designated ski track. Other venues such as skate parks could use the described components in embodiments to take images of skaters at locations as they use various skate ramps.

Event planners can use the described components to place the event guests in positions at different event venue locations that allow images to be taken and edited with additional filters or backgrounds. In many of the embodiments, when a photo is taken by a specific fixed location camera similar to a camera in a photo booth, a URL of where the photo will be stored online is transmitted via BLE to the user's mobile device, and the photo is uploaded to an internet accessible remote server. In some embodiments, the image captures could be sent back to the user directly wirelessly such as with Bluetooth.

In several embodiments with three of more beacons, the system can be used to triangulate the location of the user so the users can be tracked in physical locations and cameras actuated. In this manner, one or more shoppers can be tracked in specific locations in shops providing the stores and product placement managers data that could be used to create heat maps of where and when consumers spend their time so that changes can be made to increase sales with the use of testing.

Although the foregoing embodiments have been described in some detail by way of illustration and example for purposes of clarity and understanding, it will be apparent to those of ordinary skill in the art in light of the teaching of this inventive subject matter that certain changes and modifications may be made thereto without departing from the spirit or scope of the appended claims.

What is claimed is:

1. A system of using a beacon, the system comprising
a beacon;
a sensor;
a computer enabled device for communicating with the beacon over a wireless network; and
a remote storage device;
wherein said computer enabled device can communicate with said beacon over a wireless network;
wherein said computer enabled device detects said beacon when said beacon is within a predetermined range of said computer enabled device;
wherein once said beacon is detected said computer enabled device triggers said sensor;
wherein said sensor outputs a digital file; and
wherein said digital file is transmitted to said remote storage device.

2. The system of claim 1 wherein said sensor is more than one sensor.

3. The system of claim 1 wherein said sensor is a camera.

4. The system of claim 1 wherein said beacon is more than one beacon.

5. The system of claim 1 wherein said remote storage device is more than one remote storage devices.

6. The system of claim 1 wherein said beacon is powered by a battery.

7. The system of claim 1 wherein said wireless network is wired network.

8. The system of claim 1 wherein said wireless network is connected to the internet.

9. The system of claim 1 wherein said computer enabled device can communicate with said beacon over a wired network.

10. The system of claim 1 wherein said computer enabled device is at least one smartphone each with one or more cameras for recording and outputting images.

11. The system of claim 1 wherein said computer enabled device is at least one smartphone each with one or more audio recording devices for recording and outputting sounds.

12. The system of claim 1 wherein said computer enabled device is includes one or more scales for recording and outputting a user's weight.

13. The system of claim 1 wherein said beacon is three are more beacons that are additionally used to triangulate the location of a user and output the location data to said remote storage device.

14. The system of claim 13 wherein said image is output along with the location data to said remote storage device.

15. The system of claim 13 wherein said image is multiple images taken from multiple camera sources.

16. The system of claim 15 wherein said multiple images are used to create a 3D print file.

17. The system of claim 1 wherein said computer enabled device wireless transmits a set of alphanumeric codes to said beacon when said beacon is within a predetermined range of said computer enabled device.
